(19) United States
(12) Patent Application Publication
(10) Pub. No.: US 2024/0172726 A1
(43) Pub. Date: May 30, 2024

(54) INTERACTIVE PET TOY

(71) Applicant: CHRISTINE DE LILLO, Nyack, NY (US)

(72) Inventor: CHRISTINE DE LILLO, Nyack, NY (US)

(21) Appl. No.: 18/520,384

(22) Filed: Nov. 27, 2023

Related U.S. Application Data
(60) Provisional application No. 63/428,960, filed on Nov. 30, 2022.

(51) Int. Cl. A01K 15/02

(52) U.S. Cl. CPC A01K 15/025

(57) ABSTRACT

An interactive pet toy that includes a length of hollow tube having an axial opening in the hollow tube. A length of track is disposed along the length of the hollow tube within the axial opening. The track includes multiple track portions detachably coupled to each other to form a continuous track. A mobile toy is mounted on the continuous track and travels on the track through the length of hollow tube along the axial opening. There are at least one and preferably multiple see-through ports in the hollow tube through which the pet can observe the mobile toy moving on the continuous track through the length of hollow tube.

### RELATED APPLICATION

This application claims priority of provisional application 63/428,960 filed on Nov. 30, 2023. The entire disclosure of this provisional application is incorporated herein by reference.

### FIELD OF THE INVENTION

The present invention generally relates to an interactive pet toy for stimulating physical activity in pets, particularly cats.

### BACKGROUND OF THE INVENTION

COVID-19 pandemic forced people into self-quarantining and maintaining social distance from friends, family and co-workers. During this period of time and other times, many people chose to obtain emotional support animals (ESAs) as pets and to help them cope with anxiety, loss of loved ones, depression, and the like, brought on by the pandemic. Such ESAs included dogs, cats, birds, guinea pigs, hamsters and the like. However, the owner of such pets may not have fully realized the amount of personal attention and interaction that the pet required from its owner.

For instance, once offices, schools and workplaces resumed regular operation, the pet owner was occupied with personal engagements relating to their job, school, or family life, preventing them from providing the required personal interaction with their pets. Usually this interaction includes feeding the pet in a timely manner, taking the pet out for a walk and other activities, including playing with the pet.

It will be appreciated that cats are one of the most beloved and common pets worldwide. However, due to a cat's sedentary nature, it prefers to lie around instead. Supposedly 70% of a cat's life is sleeping or reclining. Dogs tend to be more active, but they still need activity and playtime. Such a sedentary lifestyle, particularly for cats, can cause various health complications such as obesity, diabetes and heart issues. Consequently, a pet owner, particularly a cat owner, may be required to dedicate additional time and effort to take care of their cat to prevent or mitigate such health complications that may result in the death of the pet.

There is thus a need for Interactive Pet Toys and methods that can stimulate the physical activity in a pet, particularly a cat, when their owner is unable to offer their pet direct physical interaction.

The inventor is presently aware of the following prior art references:
U.S. Pat. No. 5,579,725 to Boshears describes a cat toy having a generally hollow, circular housing containing a toy animal simulating a mouse. The toy animal is mounted on the outer end of a motor-driven arm which is moved in a circular pattern around the interior of the housing. Openings are provided in the housing, through which a cat can extend a paw to engage and play with the toy animal.
U.S. Pat. No. 8,944,011 to Kirschbaum describes a cat toy that includes an clastic cord with which the cat can play.
U.S. patent Ser. No. 10/477,837 to Liu et al. describes an interactive cat toy that has a motor driven “object of prey” that attracts the attention of the cat by moving from a recessed position and an extended position.

### SUMMARY OF THE INVENTION

The present invention generally relates to Interactive Pet Toy for stimulating physical activity in pets, particularly cats. The Interactive Pet Toy includes a hollow tube which comprises an inner opening or space. The Interactive Pet Toy also includes a track that may be disposed in the inner opening or space within the tube. The track may include multiple sections of track portions, wherein each track portion can be detachably connected to another track portion. The track may be assembled to create various shapes, e.g., a figure 8. A mobile toy, for example simulating a mouse, moves along the continuous track. The hollow tube can be made of a fabric type material. The hollow tube has at least one see-through opening or port, and preferably several such see-through ports, on the top the hollow tube to enable the pet to see through the port and be attracted to the mobile toy that can continuously travels around the track.

In one embodiment a track portion includes a first snap fitting element disposed at a first end and a second snap fitting element disposed at a second end. The second snap fitting element may be configured to be detachably coupled with the first snap fitting element of an adjacent portion. The multiple portions of the track may be detachably coupled to each other using a snap-fitting joint. A mobile toy can be configured to move on the track within the hollow tube. Such mobile toy may include a motor driven roller disposed at an underside of the mobile toy.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A and FIG. 1B show the assembled Interactive Pet Toy for stimulating physical activity in pets, e.g., cats (FIG. 1A) and the hollow tube used in the Interactive Pet Toy.

FIG. 2 shows a sectional view of the hollow tube, in accordance with an embodiment of the present invention.

FIG. 3 shows a sectional view of the hollow tube, in accordance with another embodiment of the present invention.

FIG. 4 shows several portion of a track length coupled together, in accordance with an embodiment of the present invention.

FIG. 5 shows an exploded view of two track portions of the length of track and the snap fitting joints, in accordance with an embodiment of the present invention.

FIG. 6 shows a side view of the two track portions of FIG. 5 forming a track length detachably coupled to each other using the snap-fittings.

FIG. 7 shows a bottom view of the two track portions of FIG. 6 forming a track length detachably coupled to each other using a snap-fitting.

FIG. 8 shows a side view of the mobile toy animal simulating a mouse used in an embodiment of the present invention.

FIG. 9 shows an underside view of the mobile toy of FIG. 8 showing a a drive motor on the underside of the mobile toy to drive the toy travel over the continuous track.

FIG. 10 shows a sectional view of the underside of the mobile toy of FIG. 9.

FIG. 11 shows the mobile toy running on a portion of the track (hollow tube not shown).

FIG. 12 shows a sectional view of the underside of the mobile toy running on a portion of the track.

FIG. 13 shows a sectional view of the track, in accordance with an embodiment of the present invention.

FIG. 14 shows a sectional view of the track shown in FIG. 13.

FIG. 15 shows a perspective view of the assembled invention forming a continuous closed loop track formed in a FIG. 8 wherein the mobile toy mounted on the track can continuously travel through the hollow tube.

### DETAILED DESCRIPTION

The following discussion provides examples of embodiments of the invention. Although each embodiment represents a single combination of inventive elements, the inventive subject matter is considered to include all possible combinations of the disclosed elements.

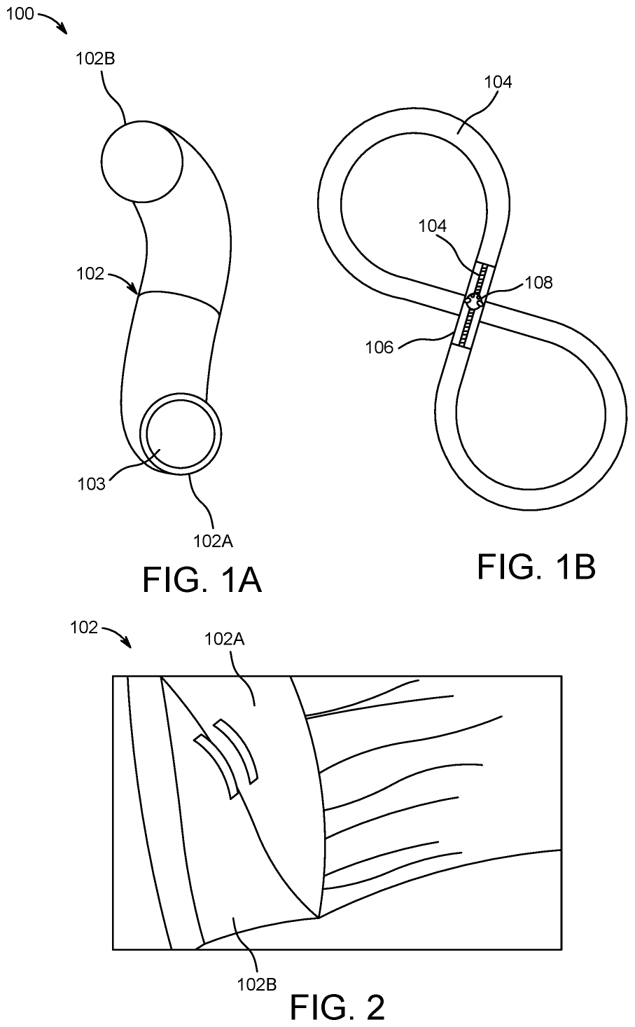

Referring to FIG. 1A, the Interactive Pet Toy 100 for stimulating physical activity in pets is depicted. The Interactive Pet Toy 100 can be employed to keep one or more pets engaged in physical activity without the aid of their owner. The Interactive Pet Toy 100 enables you to keep the pets, such as cats, entertained for a prolonged period of time when the owner of the pet is unable to focus their attention on the pet. The Interactive Pet Toy 100 enables you to continuously provide stimulation for physical activity in pets at low cost and effort by the owner, while ensuring safety and comfort for the pet.

Referring to FIG. 1B, there is shown a top view of an embodiment of the Interactive Pet Toy 100 for stimulating physical activity in pets. The Interactive Pet Toy 100 comprises a hollow tube 102, FIG. 1B, having a first end 102A and a second end 102B. The hollow tube 102, although part of the Interactive Pet Toy 100 assembly, may be used alone (without the tracks) to stimulate the pet by permitting the cat to enter and exit into the hollow tube 102 from either end. However, the hollow tube 102 is an essential element of the assembly of Interactive Pet Toy 100.

In one embodiment, the hollow tube 102 can be fabricated from a scratch-resistant fabric, such as a scratch-resistant microfiber fabric. It can be appreciated that the cat may become tempted to physically engage with the hollow tube 102 such as by clawing or scratching the hollow tube 102. Consequently, the scratch-resistant fabric reduces the wear and tear on the hollow tube 102 during prolonged use of the Interactive Pet Toy 100.

Referring to FIGS. 1A, 1B and 2, in this embodiment, the first end 102A of the hollow tube 102 is configured to be detachably coupled to the second end 102B of the hollow tube 102, such that the hollow tube 102 forms a continuous closed shape. In one example, the closed shape corresponds to a circular or an oval shape. In another example, as depicted in FIGS. 1B and 15, the closed shape corresponds to a figure-8 shape.

Referring to FIG. 2, there is shown a sectional view of the hollow tube 102, in accordance with an embodiment of the present disclosure. However, the hollow tube 102 can be a collapsible cat play tunnel, extendable 5-way tunnels, a 4-way cat tunnel, 3-way cat tunnel or any other suitable shape.

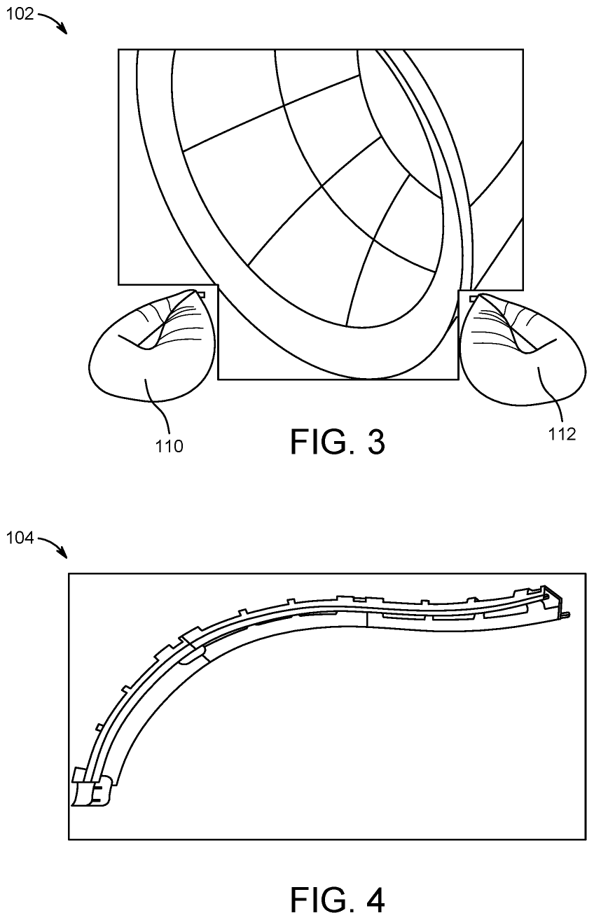

Referring to FIG. 3, the hollow tube 102 may include a first set of weighted poly-filled feet 110 disposed along one side of the hollow tube 102 and a second set of weighted poly-filled feet 110 disposed along the other opposed side of the hollow tube for maintaining the hollow tube 102 on a plane surface, e.g., floor or a table top.

Referring to FIGS. 1B, 13-15, the hollow tube 102 has at least one and preferably multiple see-through ports 106 used to engage a cat or other pet for physical activity as the mobile toy animal 108 travels through the hollow tube 102. The hollow tube 102 has a continuous track 104 deployed and securely placed therein. The see-through ports 106 (i.e., peek holes) are present on surface of the hollow tube 102. The length of the hollow tube 102 can be, for example, 30-50 inches. The holes or openings 106 in the tube 102 are arranged to enable visibility through the oblong see-through port 106 from outside of the tube 102. The pet can look through the opening(s) 106 and see the mobile toy 108 moving on the track 104. Upon looking at toy 108 from outside through the see-through ports 106 (i.e., peek holes) the cat or other pet becomes engaged with the Interactive Pet Toy 100 trying to catch the mobile toy 108 which is hidden within the hollow tube 102 and only becomes visible through the see-through ports 106 as it travels through the tube 102. Thus the Interactive Pet Toy 100 engages the pet, e.g., cat, to provide enhanced physical activity.

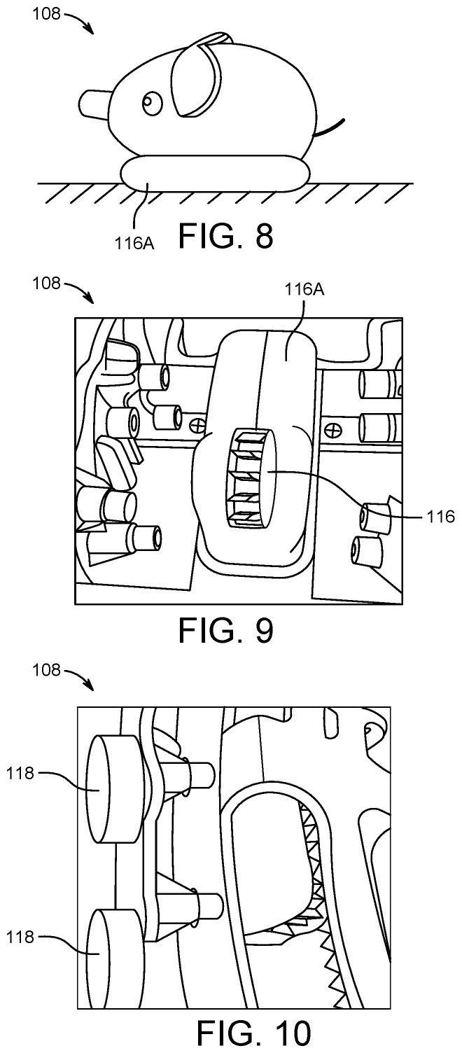

The track 104 can be formed from multiple track portions, wherein each track portion 104 is configured to be detachably coupled to another track portion 104 to construct various sizes and shapes, e.g., oval, figure 8, etc. of continuous track. The track 104 is configured or disposed within the hollow tube 102. It can be appreciated that a user, such as the pet owner, may need to move the Interactive Pet Toy 100 to another location within the home or move the track for travelling. Consequently, the detachable coupling of the multiple track portions 104 enables the user to disassemble the track 104 and carry the Interactive Pet Toy 100 with them in a compact and convenient manner.

In an embodiment, the multiple track portions 104 that form the continuous track are detachably coupled to each other using snap-fitting. For example, the multiple portions of the track 104 are implemented such that one portion can be coupled to two other portions of the track 104 via snap-fitting. The track 104 can be fabricated from any suitable material such as HDPE, PVC, carbon fibre, hard plastic, and the like.

Referring to FIG. 8, the Interactive Pet Toy 100 includes a mobile toy 108 configured to be movably received on the track 104 and to travel and move along the track 104 within the hollow tube 102. It will be appreciated that pet animals such as cats and dogs are stimulated by the movement of the toy 108. For example, dragging a ball of wool on the ground in front of a cat causes the cat to chase the ball. The movement of the mobile toy 108 on the track 104 within the hollow tube 102 and viewed by cat through the see-through ports 106 stimulates the cat to physical activity. In one example, the mobile toy 108 is a simulated mouse.

During operation of the Interactive Pet Toy 100, the mobile toy 108 implemented as the toy mouse, moves on the track 104, appearing within the oblong see-through port 106. When the cat observes the toy mouse 108 moving in the hollow tube 102, the cat is tempted to chase the movement of the toy mouse 108, thereby stimulating physical activity for the cat.

In one embodiment, the tube 102 includes multiple oblong see-through ports 106. The hollow tube 102 can be provided with a number of viewing ports 106 all along the length of the hollow tube 102 or at regular intervals so that the cat is able to see the mobile toy 108 as it moves through the tube 102 promoting an interest by the cat in catching or following the mobile toy 108.

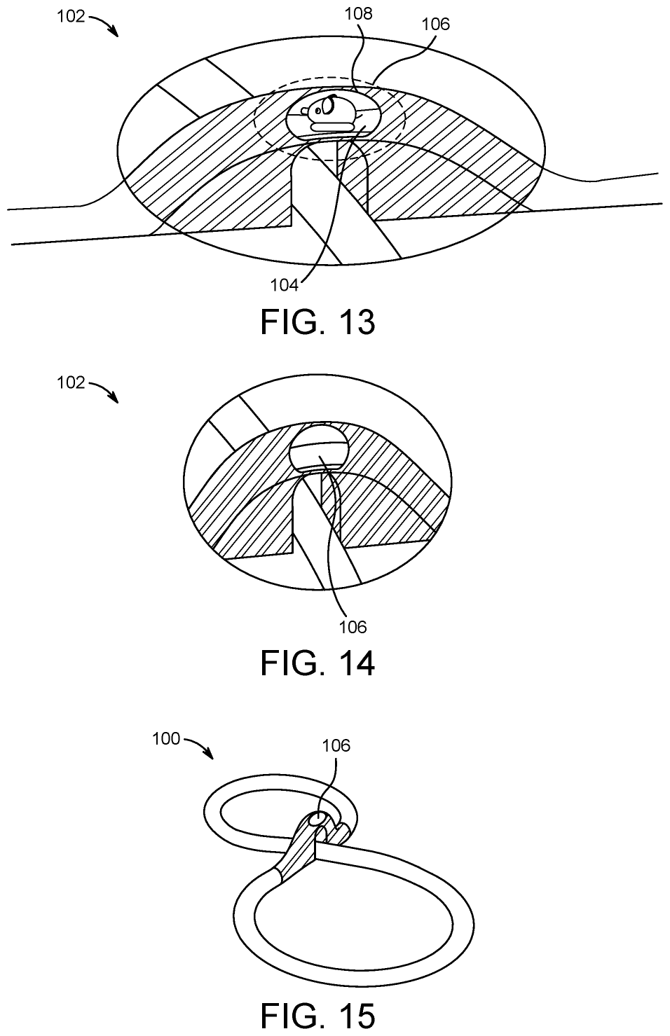

For example, referring to FIGS. 13-15, an oblong see-through port 106 may be disposed at selected locations along the length of the hollow tube 102. Such multiple oblong see-through ports 106 ensure that the pet is able to view the mobile toy 108 moving inside the hollow tube 102. Consequently, the pet remains interested in playing with the Interactive Pet Toy 100 for prolonged periods of time without losing focus. The track 104 can be provided with a raised (corresponding to a shape of a speed bump) or even a helical twist section near the oblong see-through ports 106 such that the mobile toy 108 running on the track 104 takes longer to run through such section. Such a raised or helical portion of the track 104 enables the mobile toy 108 to change a trajectory of movement within the hollow tube 102, thereby, ensuring that the pet remains interested in playing with the Interactive Pet Toy 100 for prolonged periods of time.

Optionally, the mobile toy 108 can powered by a battery or multiple batteries and the user can control or customize speed through on-board buttons on the mobile toy, a remote-control device or an mobile application that can be executed on a smartphone. The speed of the mobile toy 108 may be programmed to maintain a constant or variable speed. For example, the mobile toy 108 can be “slowed down” for a few seconds while the cat is able to see the toy 108 so that an interest of the cat in playing with the toy is maintained. Alternatively, the mobile toy 108 can be programmed to work in different speed modes.

In another embodiment, each track portion 104 and the mobile toy 108 can include 2 permanent magnets. For example, a weak permanent magnet could be disposed along the track 104 at certain distances and the mobile toy 108 could also be provided with a weak permanent magnet of opposite polarity. Thus, when the mobile toy 108 runs along the track 104 having these magnets, the mouse is slowed down, preventing the cat from being able to predict when the mouse will arrive at the intersection of figure 8-shape or in the opening 106. The permanent magnets disposed on the track 104 can attract or repel the permanent magnets disposed on the mobile toy 108, thereby, ensuring that the mobile toy 108 moves in an unpredictable manner on the track 104 and thus, ensuring that the pet remains interested in playing with the Interactive Pet Toy 100 for prolonged durations.

In another embodiment, the mobile toy 108 is configured to output visual, auditory and/or olfactory stimuli. It can be appreciated that cats react to visual stimulus, such as, by chasing laser lights, auditory stimulus such as particular sounds (sounds of bird chirping and the like) as well as olfactory stimulus including smells of foods and the like.

In another embodiment, the mobile toy 108 running on the track 104 can be provided with a blinking/laser light source that is activated at predetermined intervals or randomly so that the pet becomes interested in playing with it whenever the cat sees the light. Similarly, the toy 108 could make squeaking/chirping sounds that would tempt the cat to play with it. Optionally, the toy 108 could release a puff of a specific fragrance (such as that of cat food or any smell that could arouse the cat) to tempt the cat to play with the mobile toy 108.

Referring to FIGS. 4-7, there is shown a portion of the track 104 that may be used in an embodiment of this invention. Each portion of the track 104 includes a lower surface that rests in the hollow tube 102. Each track portion includes a pair of parallel lips 115 and series of snap fitting elements 114 to securely hold the other track portion 104. Each track portion 104 includes a first snap fitting element 114 (e.g., a male insert) disposed at first end and a second snap fitting element 113 (e.g., a female insert) that is arranged at second end. The user can detachably couple the two adjacent track portions by utilizing snap fitting between first snap fitting elements 114 and second snap fitting element 114. Other type connectors can be used to connect the track portions 104 to provide a continuous track for the mobile toy 108 to travel along.

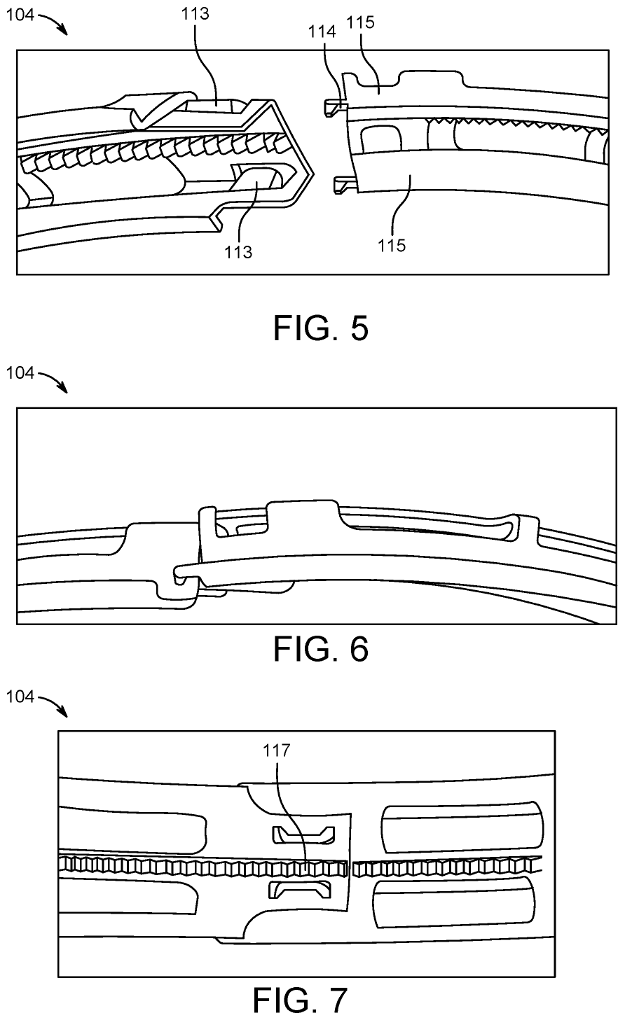

Referring to FIG. 5 there is shown a side view of two track portions 104 that are detachably coupled to each other using the snap-fitting.

Referring to FIGS. 5 and 7, there is shown a bottom view of two track portions 104 that are detachably coupled to each other using snap-fitting, 113 and 114. Upon fitting of the two track portions, centre roller-teeth 117 are aligned with each other to enable smooth ride of mobile toy 108 along track portion 104. 117A

Referring to FIG. 8-10, there is shown various views of the mobile toy 108. Mobile toy 108 includes a drive module 116A (e.g., electric motor), external gear module (e.g., roller 116) that is driven by the drive module 116A. The external gear 116 can extend outwardly from bottom side of toy 108 and arranged to mesh with roller teeth 117 (see FIGS. 5 and 7) of track 104. As drive module 116A generates torque to drive the external gear to provide forward or backward movement to mobile toy 108.

Referring to FIG. 9, there is shown an underside view of the mobile toy 108. As shown, the mobile toy 108 comprises a roller 116 disposed at an underside of the mobile toy 108. The roller 116 is received on the track 104 such that rolling of the roller 116 causes movement of the mobile toy 108 along the track 104. According to an embodiment, the roller 116 is operably connected to a DC motor 116A and a power source (such as a rechargeable battery). The DC motor can be actuated to cause uninterrupted movement of the mobile toy 108 on the track 104 as long as desired by the pet owner.

Referring to FIG. 10, there is shown a sectional view of the underside of the mobile toy 108, in accordance with an embodiment of the present disclosure. As shown, the mobile toy 108 comprises multiple aligners 118 for mobile arrangement of the mobile toy 108 on track 104. It will be appreciated that during usage of the Interactive Pet Toy 100, the pet may interact with the Interactive Pet Toy 100, such as, by pushing or pulling the hollow tube 102, causing the mobile toy 108 to tip over from the track 104. The multiple aligners 118 on the mobile toy 108 prevent such tipping over of the mobile toy 108 from the track 104, thereby, ensuring prolong and reliable operation of the Interactive Pet Toy 100. In one example, each of the multiple aligners 118 may be wheels of the mobile toy 108.

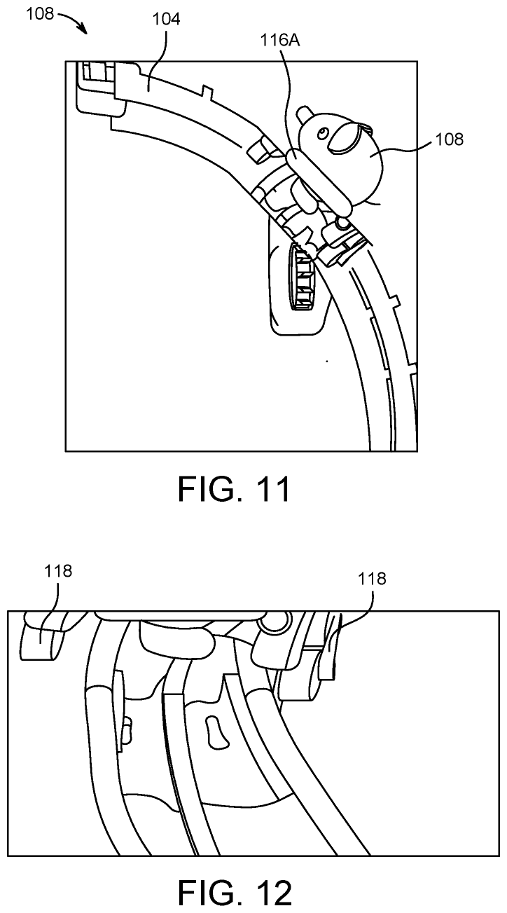

Referring to FIG. 11, there is shown the mobile toy 108 running on a portion of the track 104 with the hollow tube 102 not shown.

Referring to FIG. 12, there is shown a sectional view of the underside of the mobile toy 108 movably arranged on the track 104, in accordance with an embodiment of the present disclosure.

Referring to FIGS. 13-15, there is shown a sectional view of the track 104, in accordance with an embodiment of the present disclosure. The track 104 is implemented to have the shape of figure 8. As shown, the first portion of the track 104 comprising the oblong see-through port 106 overlaps over with the second portion of the track 104 that is placed on floor. Consequently, the first portion of the track 104 forms a “bridge” over the second portion of the hollow tube 102. Moreover, the mobile toy 108 appears within the oblong see-through port 106 on its journey along the track 104. The oblong see-through port 106 can be fabricated using a see-through material such as polyethylene to enable the inside view and moving toy 108 on the track 104 can be viewed at the location. The tunnel can be flat except for the center plastic piece.

Referring to FIG. 14, there is shown a sectional view of the track 104 shown in FIG. 13, in accordance with another embodiment of the present disclosure. In reference to FIG. 13, the mobile toy 108 has moved away from the oblong see-through port 108 in FIG. 14. As mobile toy 108 can pass through this area of track 104, it become visible to cat. The elevated portion is arranged in manner that it aligns with hole of hollow tube 102. A draw string can be utilized to store/carry toy when unassembled.

Referring to FIG. 15, there is shown an isometric view of the track 104, in accordance with an embodiment of the present disclosure.

It will be appreciated that although the Interactive Pet Toy 100 is explained with respect to cats, the Interactive Pet Toy 100 can be easily adapted to stimulate physical activity in other pets such as dogs and birds with minor modifications to the Interactive Pet Toy 100. For example, when the pet is a dog, the mobile toy 108 can be implemented as a cat toy or a chew toy that causes the dog to chase the mobile toy 108, thereby, stimulating physical activity for the dog.

| Reference Numeral | Description |
|---|---|
| 100 | Interactive Pet Toy |
| 102, 102A and 102B | Hollow tube having a first end 102A |
| | and a second end 102B |
| 103 | Axial opening or space |
| 104 | Track portions |
| 106 | Oblong see-through port |
| 108 | Mobile toy animal simulating a mouse |
| 110 | Left set of weighted poly-fill feet |
| 112 | Right set of weighted poly-fill feet |
| 113 | Second snap fitting element (female) |
| 114 | Snap-fitting elements (male) |
| 115 | Parallel lips |
| 116 | Roller in underside of mobile toy 108 |
| 116A | Drive module on mobile toy |
| 117 | Series of roller teeth |
| 118 | Aligners |

It should be apparent to those skilled in the art that many more modifications besides those already described are possible without departing from the inventive concepts herein. The inventive subject matter, therefore, is not to be restricted except in the spirit of the appended claims.

1. An interactive pet toy comprising:
a length of hollow tube comprising an axial opening in the hollow tube;
a length of track disposed along the length of the hollow tube within the axial opening, wherein the track comprises multiple track portions detachably coupled to each other to form a continuous track;
a mobile toy mounted to the continuous track and mobile on the continuous track through the length of hollow tube along the axial opening;
at least one see-through port in the hollow tube through which the pet can observe the mobile toy moving on the continuous track through the length of hollow tube.

2. The interactive pet toy of claim 1, wherein the hollow tube has multiple see-through ports along the length of the hollow tube.

3. The interactive pet toy of claim 1, wherein the length of hollow tube forms a closed loop wherein the mobile toy mounted on the continuous track can continuously travel through the hollow tube.

4. The interactive pet toy of claim 2, wherein the length of hollow tube forms a figure 8.

5. The interactive pet toy of claim 1, wherein the hollow tube is a fabric.

6. The interactive pet toy of claim 1, wherein the hollow tube is a scratch resistant fabric.

7. The interactive pet toy of claim 1, wherein the hollow tube further comprises weighted feet on each side of the hollow tube to maintain a stable position for the hollow tube.

8. The interactive pet toy of claim 1, wherein the mobile toy comprises a drive motor to drive the mobile toy over the continuous track.

9. The interactive pet toy of claim 1, wherein the mobile toy includes a drive motor wherein the speed of travel of the mobile toy over the continuous track can be programmed into the mobile toy.

10. The interactive pet toy of claim 1, wherein the mobile toy includes an output for visual, auditory, or olfactory stimuli.

11. The interactive pet toy of claim 10, wherein the mobile toy includes a laser beam as a visual stimuli.

12. The interactive pet toy of claim 1, wherein the multiple portions of the track are detachably coupled to each other using a snap-fitting joint at each end of the track.
